(19) United States
(12) Patent Application Publication
(10) Pub. No.: US 2013/0246600 A1
(43) Pub. Date: Sep. 19, 2013

(54) COMMUNICATION SERVICE PROVIDING SYSTEM, METHOD OF PROVIDING COMMUNICATION SERVICE AND DATA CENTER MANAGEMENT SYSTEM

(71) Applicant: Masato Ohnishi, Minato-ku (JP)

(72) Inventor: Masato Ohnishi, Minato-ku (JP)

(73) Assignee: NEC CORPORATION, Minato-ku, Tokyo (JP)

(21) Appl. No.: 13/824,182

(22) PCT Filed: Nov. 30, 2011
(86) PCT No.: PCT/JP2011/006702

§ 371 Date: May 9, 2013

(30) Foreign Application Priority Data
Dec. 8, 2010 (JP) 2010-273746

(51) Int. Cl. H04L 12/24

(52) U.S. Cl. CPC H04L 41/50
USPC 709/223

(57) ABSTRACT

Provided is a communication service providing system capable of providing the same level of services independently of a location where a user's terminal exists and capable of providing a service to a user via a network appropriate to the service. Location information collection means 71 collects location information on a terminal of a user receiving a service from any one of the data centers. User data and the like transfer instruction means 72 determines a data center closest to a location indicated by the location information and, in the case where the data center differs from the data center currently providing the service to the user, instructs the data center currently providing the service to the user to transfer the user data and the user area of the user to the data center closest to the location indicated by the location information.

### TECHNICAL FIELD

The present invention relates to a communication service providing system which provides a service via a network from a data center, a method of providing communication service therefor, and a data center management system and a data center management program which are applied to the communication service providing system, and particularly to a communication service providing system capable of providing services with the same level of communication quality independently of a user's location, a method of providing communication service therefor, and a data center management system and a data center management program which are applied to the communication service providing system.

### BACKGROUND ART

In recent years, services provided to a user via a network from a data center increases. It also rapidly increases users of such services. A data center which provides services to users via a network and a server or the like in the data center is referred to as a cloud.

In this service providing mode, a plurality of data centers are provided in order to provide services while defining a storage area for an individual user which the user is able to use in a storage in the data center and storing user data in the storage area. This storage area is called a use area or a user area. The content of the service to be provided is not particularly limited and the content of the user data depends on the type of service.

A user is able to receive a desired service by performing processing according to the service while a user's terminal device and a data center (more specifically, a server in the data center) send and receive information.

In addition, a network between the user's terminal device and the data center is called an access network. Networks to be access networks are provided by various communication carriers. A network (access network) is provided for a communication carrier and the quality of service (QoS) depends on the network. Further, Patent Literature (PTL) 1 describes an application program move position decision method of deciding an appropriate destination for an application program or a data file according to a user's location on the network.

### CITATION LIST

### Patent Literature(s)

PTL 1: Japanese Patent Application Laid-Open No. 11 (1999)-143836

### SUMMARY OF INVENTION

### Technical Problem

Although the user area of an individual user is provided in the storage in the data center as described above, the user cannot recognize in which data center his/her own user area is provided and from which data center the user receives the service. Further, if the physical distance between the user's terminal and the data center which ensures the user area of the user and provides the service to the user is too long, access time from the user's terminal to the data center increases or the throughput decreases, thereby reducing the user experience at the time of using the service.

FIG. 15 is an explanatory diagram schematically illustrating the physical distance between the user's terminal and data centers. A data center group 81 including data centers 82a to 82c and the like is managed by the same cloud service provider. The data centers 82a to 82c are arranged in regions different from each other. In the example illustrated in FIG. 15, the data center 82a, the data center 82b, and the data center 82c are arranged in a region A, a region B, and a region C, respectively. The data center 82a includes a storage 83a, a server 84a, and network equipment 85a. Hereinafter, the network is sometimes referred to as simply NW. The storage 83a is a storage device to which a user area is allocated, and user data is stored in the user area. The server 84a is an information processor which provides a service by communicating with a user's terminal 87. The network equipment 85a is an interface with a network in the data center 82a. Similarly, the data center 82b includes a storage 83b, a server 84b, and network equipment 85b. The data center 82c also includes a storage 83c, a server 84c, and network equipment 85c.

Further, in FIG. 15, there are illustrated networks 91a to 91e as access networks. In this example, the individual networks 91a to 91e are networks for communication carriers A, B, C, D, and E different from each other. The qualities of service of the networks 91a to 91e are different from each other, too. Moreover, a network utility rate for performing communication depends on each network.

Further, it is assumed that the user area of the user using the terminal 87 is provided in the storage 83a in the data center 82a and the user receives a service from the server 84a. If the user's terminal 87 exists in the region A, an access path from the terminal 87 to the data center 82a is short, and therefore the communication delay time is expected to be short when the user enjoys the service on the data center 82a by using the terminal 87. On the other hand, it is assumed that the user and the terminal 87 have moved from the region A, where the data center 82a is arranged, to a region C, which is distant from the region A. Then, the access path from the terminal 87 to the data center 82a is a relatively long path. It is expected that the increase in the path increases the delay time when accessing from the terminal 87 to the data center 82a.

Specifically, if the same user attempts to receive the same service from the data center 82a, there is a difference in the communication delay time when attempting to receive the service, depending on which region the user exists in. This means that the communication quality of service changes according to the user's location

Moreover, although PTL 1 describes a method for deciding the appropriate destination, such as an application program in accordance with the user's location, unless the application program, data files, and the like are actually moved, it is impossible to solve the above problem that the communication quality of service changes according to the user's location. In other words, the above problem cannot be solved by simply deciding the destination.

In addition, the services provided by the data centers 82a to 82c are not limited to one type and the data centers 82a to 82c provide various services. Further, for example, whether to use only a narrow bandwidth or to use a wide bandwidth, whether to allow delay to a certain degree or preferably to minimize the delay, and the like depend on the type of service. Specifically, there is a difference in the quality of service requested to the network depending on the type of service. On the other hand, if the user's terminal 87 accesses a network of a certain communication carrier and starts the use of the service of the data center via the network, the user has not been able to receive the same service only via the first accessed network unless the user intentionally operates the terminal 87 to change the network, Therefore, unless the quality of the network required for the service which the user wants to use matches the quality of the network which the user accessed (e.g., if the network delay time is too large or if the amount of bandwidth is too small), it has been required to change the network that the user accesses by intentionally performing the operation.

Therefore, it is an object of the present invention to provide a communication service providing system capable of providing the same level of services independently of a location where a user's terminal exists and providing services to a user via a network appropriate to the service, a method of providing communication service therefor, and a data center management system and a data center management program which are applied to the communication service providing system.

### Solution to Problem

A communication service providing system according to the present invention includes: a plurality of data centers which provide services to a user by communicating with a terminal of the user; and a data center management system which manages the respective data centers, wherein: each data center, when providing the service to the user, secures a user area which is a storage area for the user for use in providing the service and stores user data which is data for the user for use in providing the service into the user area; and the data center management system includes: location information collection means for collecting location information on the terminal of the user receiving the service from any one of the data centers; user data and the like transfer instruction means for determining a data center closest to a location indicated by the location information and, in the case where the data center differs from the data center currently providing the service to the user, instructing the data center currently providing the service to the user to transfer the user data and the user area of the user to the data center closest to the location indicated by the location information; service type and the like collection means for collecting information on the type of service provided to the user and the type of network used for providing the service to the user from the respective data centers; and network switching control means for determining the type of network appropriate to the type of service provided to the user by the data center and, in the case where the type of network does not match the information on the type of network collected by the service type and the like collection means, performing control to switch the network used for providing the service to the user to the network appropriate to the type of service.

A data center management system according to the present invention manages a plurality of data centers which provide services to a user by communicating with a terminal of the user, secures a user area which is a storage area for the user for use in providing the services when providing the services to the user, and stores user data which is data for the user for use in providing the services into the user area, and the center management system includes: location information collection means for collecting location information on the terminal of the user receiving the service from any one of the data centers; user data and the like transfer instruction means for determining a data center closest to a location indicated by the location information and, in the case where the data center differs from the data center currently providing the service to the user, instructing the data center currently providing the service to the user to transfer the user data and the user area of the user to the data center closest to the location indicated by the location information; service type and the like collection means for collecting information on the type of service provided to the user and the type of network used for providing the service to the user from the respective data centers; and network switching control means for determining the type of network appropriate to the type of service provided to the user by the data center and, in the case where the type of network does not match the information on the type of network collected by the service type and the like collection means, performing control to switch the network used for providing the service to the user to the network appropriate to the type of service.

A method of providing communication service is characterized by that: a plurality of data centers provide services to a user by communicating with a terminal of the user; when providing the service to the user, each data center secures a user area which is a storage area for the user for use in providing the service and stores user data which is data for the user for use in providing the service into the user area; and a data center management system which manages the respective data centers performs the operations of: collecting location information on the terminal of the user receiving the service from any one of the data centers; determining a data center closest to a location indicated by the location information and, in the case where the data center differs from the data center currently providing the service to the user, instructing the data center currently providing the service to the user to transfer the user data and the user area of the user to the data center closest to the location indicated by the location information; collecting information on the type of service provided to the user and the type of network used for providing the service to the user from the respective data centers; and determining the type of network appropriate to the type of service provided to the user by the data center and, in the case where the type of network does not match the collected information on the type of network, performing control to switch the network used for providing the service to the user to the network appropriate to the type of service.

A data center management program according to the present invention is installed on a computer which manages a plurality of data centers each of which provides a service to a user by communicating with a terminal of the user and, when providing the service to the user, secures a user area which is a storage area for the user for use in providing the service, and then stores user data which is data for the user for use in providing the service into the user area, and the data center management program causes the computer to perform: a location information collection process of collecting location information on the terminal of the user receiving the service from any one of the data centers; a user data and the like transfer instruction process of determining a data center closest to a location indicated by the location information and, in the case where the data center differs from the data center currently providing the service to the user, instructing the data center currently providing the service to the user to transfer the user data and the user area of the user to the data center closest to the location indicated by the location information; a service type and the like collection process of collecting information on the type of service provided to the user and the type of network used for providing the service to the user from the respective data centers; and a network switching control process of determining the type of network appropriate to the type of service provided to the user by the data center and, in the case where the type of network does not match the information on the type of network collected in the service type and the like collection process, performing control to switch the network used for providing the service to the user to the network appropriate to the type of service.

### Advantageous Effects of Invention

According to the present invention, it is possible to provide the same level of services independently of the location where a user's terminal exists and to provide services to a user via a network appropriate to the service.

### BRIEF DESCRIPTION OF DRAWINGS

FIG. 1 is a block diagram illustrating a configuration example of a communication service providing system of the present invention.

FIG. 2 is a block diagram illustrating a configuration example of a data center management system 1.

FIG. 3 is a conceptual diagram of the operation of a communication service providing system according to the present invention.

FIG. 4 is a flowchart illustrating an example of a processing progress of the data center management system 1 for a transfer of a user area and the like in a first method.

FIG. 5 is an explanatory diagram illustrating exchanges of an instruction and the like between the data center management system, data centers, a location information server, and a subscription server in the first method.

FIG. 6 is a flowchart illustrating an example of a processing progress of the data center management system 1 for a transfer of a user area and the like in a second method.

FIG. 7 is an explanatory diagram illustrating exchanges of an instruction and the like between the data center management system, the data centers, the location information server, and the subscription server in the second method.

FIG. 8 is a conceptual diagram of a switching operation of a network appropriate to a service type.

FIG. 9 is a flowchart illustrating an example of a processing progress of the data center management system 1 for network switching.

FIG. 10 is an explanatory diagram illustrating exchanges of an instruction and the like between the data center management system, the data centers, and NW controllers in a network switching process.

FIG. 11 is an explanatory diagram illustrating an optimization target range 71 for the access network switching in a protocol stack.

FIG. 12 is an explanatory diagram illustrating an optimization target range 81 in a protocol stack in the case of performing network switching by using data centers and a terminal

FIG. 13 is a block diagram illustrating a minimum configuration example of the communication service providing system of the present invention.

FIG. 14 is a block diagram illustrating a minimum configuration example of the data center management system of the present invention.

FIG. 15 is an explanatory diagram schematically illustrating a physical distance between a user's terminal and data centers.

### DESCRIPTION OF EMBODIMENT(S)

Hereinafter, exemplary embodiments of the present invention will be described with reference to accompanying drawings.

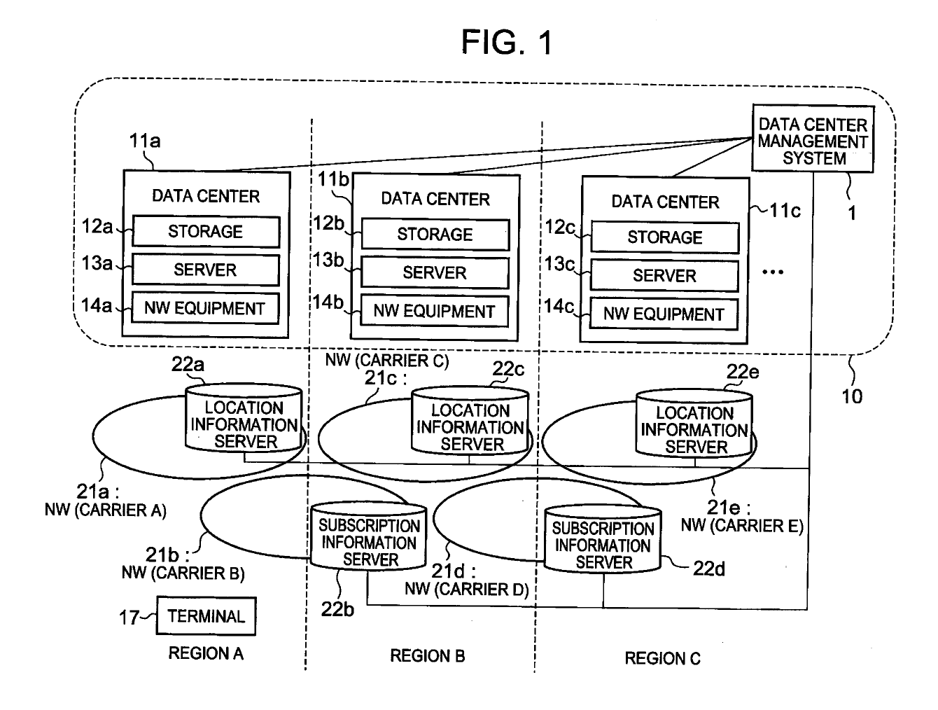

FIG. 1 is a block diagram illustrating a configuration example of a communication service providing system of the present invention. A communication service providing system 10 according to the present invention includes a plurality of data centers 11a to 11c and a data center management system 1. Although FIG. 1 illustrates three data centers 11a to 11c, the number of data centers is not limited to three and may be two or greater than three.

In the example illustrated in FIG. 1, the data centers 11a to 11c are arranged in regions different from each other. In this example, the data center 11a, the data center 11b, and the data center 11c are arranged in a region A, a region B, and a region C, respectively.

Each data center includes a storage, a server, and NW equipment (network equipment). Describing the data center 11a as an example, the data center 11a includes a storage 12a, a server 13a, and NW equipment 14a.

The server 13a communicates with a user's terminal 17 to perform processing of providing services to the user of the terminal 17. The type of service is not particularly limited, and the server 13a may perform processing according to a service. Although FIG. 1 illustrates only the terminal 17 as a user's terminal, a plurality of users exist and a plurality of user's terminals exist, too. In the following description, the terminal 17 is taken as an example of a user's terminal.

The storage 12a is a storage device which secures a user area of the user who receives a service provided by the server 13a. The user area of one user stores data which is used to receive a service provided to the user (user data) and information representing the type of service provided to the user by the server 13a. The content of the user data depends on the type of service to be provided.

The NW equipment 14a is an interface with a network in the data center 11a. The server 13a communicates with the user's terminal 17 via various networks by using the network equipment 14a to perform processing according to a service.

The data center management system 1 manages the respective data centers 11a to 11c. Specifically, the data center management system 1 collects location information on the user's terminal 17 from the networks of communication carriers and determines whether the user area of the user of the terminal 17 is secured in an appropriate data center in accordance with the location information on the terminal 17. Unless the user area of the user is secured in the appropriate data center, the data center management system 1 controls the data center to transfer the user area to the appropriate data center.

Moreover, the data center management system 1 selects a network according to the service provided to the user by the data center and controls the data center to communicate with the user's terminal 17 via the network.

FIG. 1 illustrates networks 21a to 21e as access networks (networks) for the user's terminal 17 to access data centers. Individual networks 21a to 21e are, for example, networks for communication carriers different from each other. In the example illustrated n FIG. 1, the network 21a is a network for a communication carrier A. Similarly, networks 21b, 21c, 21d, and 21e are networks for communication carriers B, C, D, and E, respectively.

The QoS (for example, a delay time or a communication band) differs for each network. Moreover, the network utility rate for performing communication differs for each network.

Moreover, a mobile carrier has a location information server which monitors the location information on the terminal (i.e., mobile terminal) of a user contracting with the communication carrier and retains the location information. The location information server updates the retained location information in the case where the terminal has moved. In the example illustrated in FIG. 1, communication carriers A, C, and E are mobile carriers and location information servers 22a, 22c, and 22e are arranged in the networks 21a, 21c, and 22e. The data center management system 1 collects location information on the terminals of users from the respective location information servers 22a, 22c, and 22e.

Moreover, a communication carrier of a fixed terminal (hereinafter, referred to as the fixed carrier) has a subscription information server which retains subscription information on each user who has a subscription contract with the fixed carrier. In the example illustrated in FIG. 1, the communication carriers B and D are fixed carriers and the subscription information servers 22b and 22d are arranged in the networks 21b and 21d. The subscription information for each user retained in each of the subscription information servers 22b and 22d contains information on the line installation location of the fixed terminal of the user who has a subscription contract (for example, information on the area where the fixed terminal is installed such as a user's address). Therefore, the subscription information also contains the location information on the user's terminal (the fixed terminal, here). The data center management system 1 collects location information on the terminal (fixed terminal) contained in the subscription information by collecting the subscription information from the respective subscription information servers 22b and 22d.

The subscription information servers 22b and 22d play the same roles as the location information servers 22a, 22c, and 22e in terms of sending the location information on the terminal to the data center management system 1. Therefore, both of the location information server and the subscription information server are able to be referred to as “terminal location information providing devices” which send location information on the respective terminals to the data center management system 1.

Moreover, each communication carrier has a network controller (not illustrated in FIG. 1 and hereinafter referred to as the NW controller) in the network of the communication carrier. For example, the communication carrier A has an NW controller in the network 21a and the communication carrier B has an NW controller in the network 21b. The same applies to other communication carriers C to E. The NW controller is a device which changes a network used for a communication between the terminal 17 and the data center in communication. The NW controller switches the network (access network) without changing, for example, an IP address allocated to the user's terminal 17. This network switching process is able to be performed by a method described, for example, in “3GPP TS23.401” which is able to be referenced in the following reference literature 1 or “3GPP TS23.402” which is able to be referenced in the following reference literature 2.

### [Reference Literature 1]

“3GPP Specification detail,” [Retrieved on Nov. 30, 2010], retrieved from the Internet: http://www.3gpp.org/ftp/specs/html-info/23401.htm

### [Reference Literature 2]

“3GPP Specification detail,” [Retrieved on Nov. 30, 2010], retrieved from the Internet: http://www.3gpp.org/ftp/specs/html-info/23402.htm

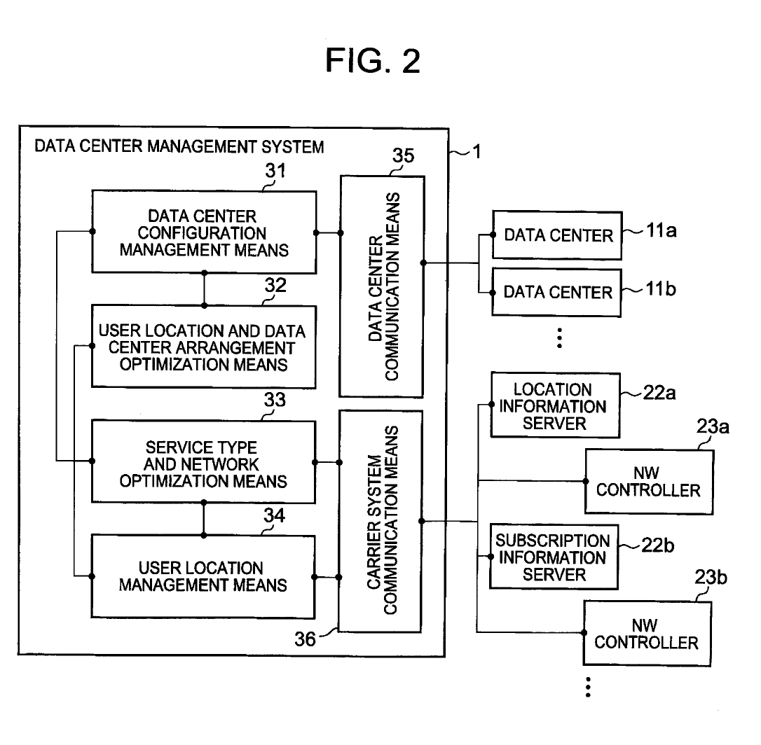

FIG. 2 is a block diagram illustrating a configuration example of the data center management system 1. The data center management system 1 includes data center configuration management means 31, user location and data center arrangement optimization means 32, service type and network optimization means 33, user location management means 34, data center communication means 35, and carrier system communication means 36.

The data center communication means 35 is a communication interface with data centers for performing communication with the data centers 11a to 11c conducted by a cloud service provider.

The data center configuration management means 31 communicates with the data centers via the data center communication means 35 to collect usage and operating conditions of the data centers and manages the collected data. For example, in addition to the system capacity of each data center, the data center configuration management means 31 collects and stores information on the capacity of the use area (user area) used by each user, the user data capacity, the CPU occupancy rates of devices in the data center, the type of service provided to the user by the data center, the user's usage condition of the service (which service the user is using), and the like from each data center.

The carrier system communication means 36 is a communication interface for communicating with devices (location information servers 22a, 22c, and 22e, subscription information servers 22b and 22d, NW controllers 23a and 23b, and the like) in the network of each communication carrier.

The user location management means 34 collects user location information (specifically, the location information on a user's terminal) via the carrier system communication means 36. For example, the user location management means 34 collects location information on the user's terminal (mobile terminal) from the location information servers 22a, 22b, and 22c in the network of the mobile carrier. Moreover, for example, the user location management means 34 collects information on the line installation location of a user's fixed terminal (for example, information on the installation area of the fixed terminal) by collecting the subscription information from the subscription information servers 21d and 22d of the fixed carrier. Specifically, the user location management means 34 collects the location information on the fixed terminal.

Further, the user location management means 34 stores the location information on the user's terminal in addition to the information on the network of the communication carrier used for an access to the data center by the user (information on the network [access network] in communication). The information on the network in communication may be collected from the data center, for example, by the data center configuration management means 31. The location information on the user's terminal stored in this manner is able to be referred to as a user location database (user location DB). In the case of a change in the location information on the user's terminal, the user location management means 34 updates the location information stored therein. Moreover, information on a network is, for example, information on the communication system of a communication carrier. Specifically, it is information on whether the network communication system is 2G, 3G, or long-term evolution (LTE), information on whether the worldwide interoperability for microwave access (WiMAX) is used, or the like. The type of network communication system as described above determines the communication quality, the service level, the utility rate of the network (access network) used by the user, and the like.

The user location and data center arrangement optimization means 32 determines whether or not the user receives a service from the appropriate data center on the basis of the information collected by the data center configuration management means 31 and the location information on the user's terminal collected by the user location management means 34. When determining that the user does not receive the service from the appropriate data center, the user location and data center arrangement optimization means 32 instructs the data center to transfer the user area and the user data from the data center currently providing the service to the appropriate data center.

The data center configuration management means 31 manages information on the type of service used by the user. The user location management means 34 manages information on the network in communication used by the user. The service type and network optimization means 33 decides an access network (network) appropriate to the service being used by the user on the basis of the above information. In this decision, the service type and network optimization means 33 selects a network enabling the user's terminal to maintain a session in communication with the data center. The service type and network optimization means 33 instructs the NW controller of the network used by the user to change the network for the user to communicate with the data center via the carrier system communication means 36.

The data center configuration management means 31, the user location and data center arrangement optimization means 32, the service type and network optimization means 33, the user location management means 34, the data center communication means 35, and the carrier system communication means 36 are implemented by, for example, a computer which includes a memory and operates according to a program. Specifically, the computer may read a data center management program to operate as the data center configuration management means 31, the user location and data center arrangement optimization means 32, the service type and network optimization means 33, the user location management means 34, the data center communication means 35, and the carrier system communication means 36 according to the program. Moreover, the data center configuration management means 31, the user location and data center arrangement optimization means 32, the service type and network optimization means 33, the user location management means 34, the data center communication means 35, and the carrier system communication means 36 may be implemented by units separate from each other.

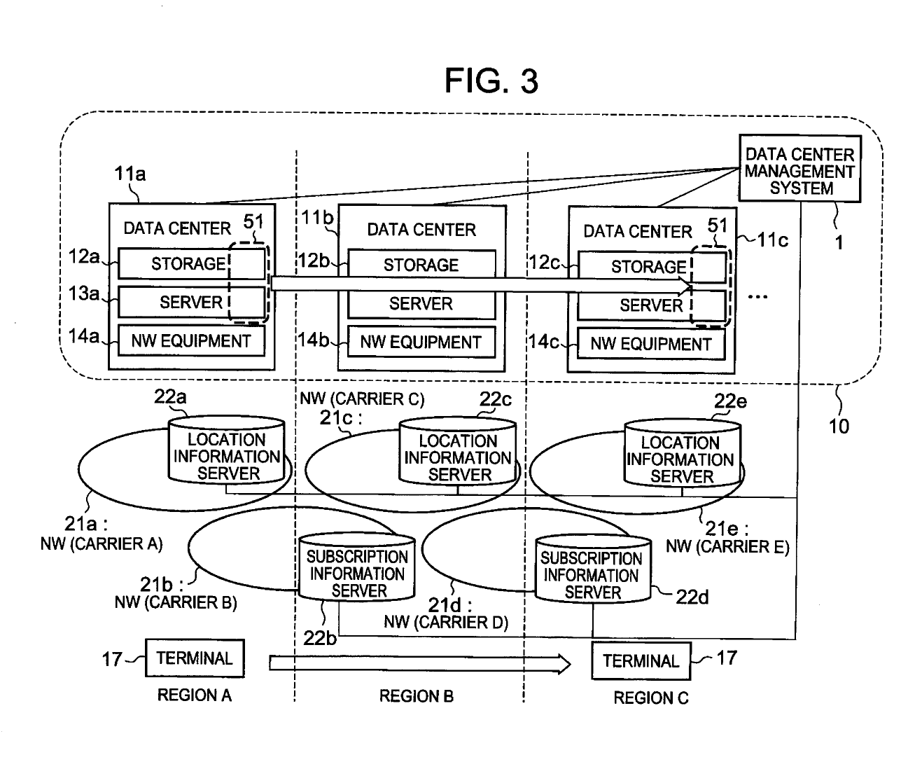

FIG. 3 is a conceptual diagram of the operation of a communication service providing system according to the present invention. If the user and the terminal 17 thereof exist in the region A, the data center 11a in the region A secures user data and a user area 51 for the user and provides a service to the user by communicating with the terminal 17.

It is assumed that the user moves and receives a service by using the terminal 17 existing in the region C. Although the terminal 17 also moves along with the user in this example here, the user having moved may use a fixed terminal in the region C in another mode. In the case where the user receives a service in the region C in this manner, the data center management system 1 transfers the user data and the user area 51 having been secured in the data center 11a to the data center 11c.

As a method of transferring user data and a user area to another data center in this manner, there are a data-center-driven method and a carrier-driven method. Hereinafter, the former is referred to as the first method and the latter is referred to as the second method.

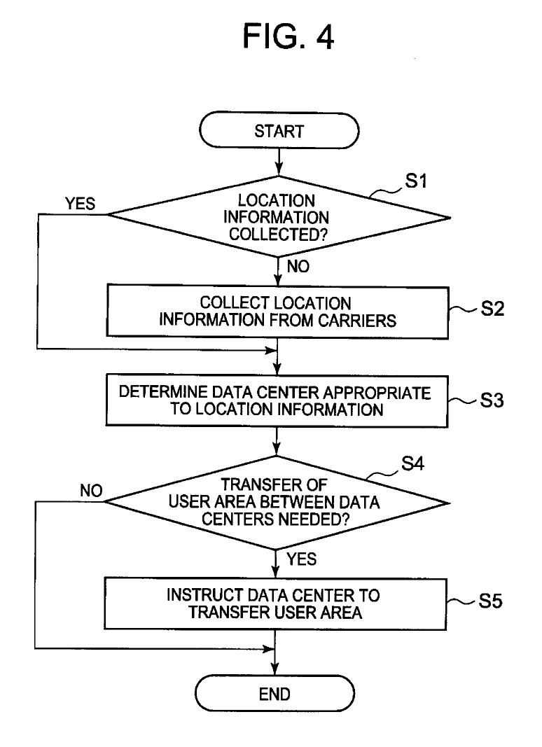

FIG. 4 is a flowchart illustrating an example of a processing progress of the data center management system 1 for a transfer of a user area and the like in the first method. As described later, the data center configuration management means 31 of the data center management system 1 constantly monitors the data centers 11a to 11c to collect the usage and operating conditions of the data centers.

Then, the user location management means 34 determines the user's terminal which receives the service from the data center on the basis of the usage and operating conditions of the data centers and determines whether or not the location information on the terminal is collected (step S1). If the location information on the terminal of the user receiving the service from the data center has already been collected (Yes in step S1), the control proceeds to step S3. If the location information on the terminal of the user receiving the service from the data center has not been collected yet (No in step S1), the user location management means 34 collects the location information on the user's terminal from terminal location information providing devices (specifically, the location information servers 22a, 22c, and 22e and the subscription information servers 22b and 22d) in the networks 21a to 21e (step S2) and then the control proceeds to step S3. Therefore, when the control proceeds to step S3, the location information on the terminal of the user receiving the service becomes referable.

In step S3, the user location and data center arrangement optimization means 32 determines the appropriate data center in accordance with the location information on the terminal of the user receiving the service (step S3). Here, the appropriate data center is, for example, a data center closest in distance to the terminal of the user receiving the service. The location information on the data center may be previously stored by, for example, the user location and data center arrangement optimization means 32. Then, the user location and data center arrangement optimization means 32 may determine the distance between the terminal and each data center by using, for example, the location information on the terminal and the location information on each data center and determine the data center closest in distance to the terminal to be a data center appropriate to the terminal.

Subsequently, the user location and data center arrangement optimization means 32 determines whether or not it is necessary to transfer the user area and the user data between data centers (step S4). If the data center currently providing the service to the user differs from the data center determined to be appropriate to the user in step S3, the user location and data center arrangement optimization means 32 determines that it is necessary to transfer the user area and the like from the data center currently providing the service to the data center determined to be appropriate (Yes in step S4). Meanwhile, if the data center currently providing the service is the same as the data center determined to be appropriate in step S3, the user location and data center arrangement optimization means 32 determines that it is unnecessary to transfer the user area and the like (No in step S4). If it is determined that the user area and the user data do not need to be transferred, the processing related to the transfer of the user area and the like is terminated.

If it is determined that the user area and the user data need to be transferred, the user location and data center arrangement optimization means 32 instructs the data center currently providing the service to the user to transfer the user area and the user data to the data center determined to be appropriate to the user in step S3 (step S5). The data center which has received the instruction transfers the user area and the like according to the instruction.

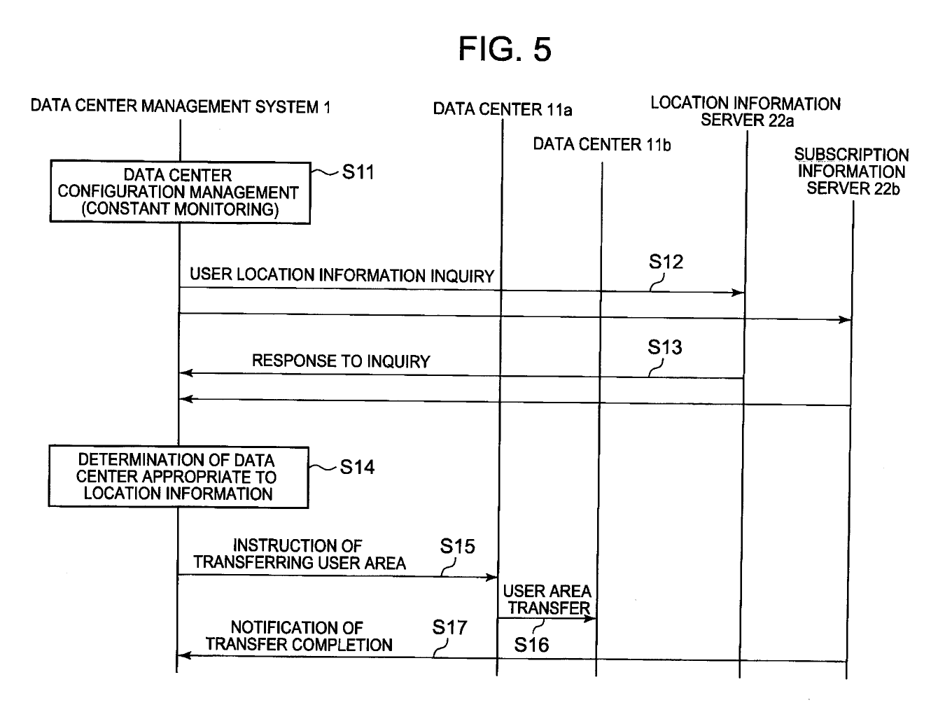

FIG. 5 is an explanatory diagram illustrating exchanges of an instruction and the like between the data center management system, data centers, a location information server, and a subscription server in the first method. The data center configuration management means 31 of the data center management system 1 constantly monitors the data centers 11a to 11c to collect the usage and operating conditions of the data centers (step S11). For example, in addition to the system capacity of each data center, the data center configuration management means 31 collects information on the capacity of the user area used by each user, the user data capacity, the CPU occupancy rates of devices in the data center, the type of service provided to the user by the data center, the user's usage condition of the service (which service the user is using), and the like. The user location management means 34 may determine the terminal of the user receiving the service from the data center on the basis of the information (step S1: See FIG. 4).

Moreover, unless the location information on the terminal of the user receiving the service from the data center is collected, the user location management means 34 collects the location information from the location information servers and the subscription information servers in the networks 21a to 21e as described above (step S2: See FIG. 4). In this process, the user location management means 34 specifies a user whose information is to be collected and inquires of the location information server 22a and the subscription information server 22b for the location information on the terminal of the user (step S12). Although the location information server 22a and the subscription information server 22b are illustrated in FIG. 5, the inquiry may be made to each location information server and each subscription information server.

Moreover, in the case of holding the location information on the terminal of the specified user, the location information server 22a, the subscription information server 22b, and the like having received the inquiry in step S12 send the location information as a response to the inquiry in step S12 to the data center management system 1 (step S13). The user location management means 34 stores the location information on the terminal received in step S13.

The data center configuration management means 31 collects the information on the network (carrier network) in communication used for the communication by the user's terminal from the data centers and the user location management means 34 also stores the information.

The user location and data center arrangement optimization means 32 then determines the appropriate data center in accordance with the location information on the terminal of the user receiving the service (step S14). The process of step S14 illustrated in FIG. 5 corresponds to the process of step S3 in FIG. 4.

The user location and data center arrangement optimization means 32 performs the determination process of step S4 (See FIG. 4) and, if determining that it is necessary to transfer the user area and the like, instructs the data center currently providing the service to the user to transfer the user area and the user data to the data center determined to be appropriate to the user in step S3 (step S15). Step S15 corresponds to step S5 illustrated in FIG. 4. In this specification, the description is made taking a case of instructing the data center 11a to transfer the user area and the user data to the data center 11b as an example. In the data center 11a instructed in step S15, for example, the server 84a requests the server 13b to secure the same user area as the user area of the user in the storage 83a in the storage 12b of the data center 11b. The server 13b of the data center 11b secures the user area in the storage 12b in response to this request. Furthermore, the server 13a of the data center 11a sends the user data of the user to the server 13b of the data center 11b to request the server 13b to store the user data into the user area secured anew. The server 13b stores the user data sent from the data center 11a into the user area secured anew (step S16). The server 13a of the data center 11a may release the user area of the user in the storage 12a.

After securing the new user area in the storage 12b and storing the user data sent from the data center 11a into the new user area, the server 13b of the data center 11b notifies the data center management system 1 of the completion of the transfer of the user area and the like (step S17).

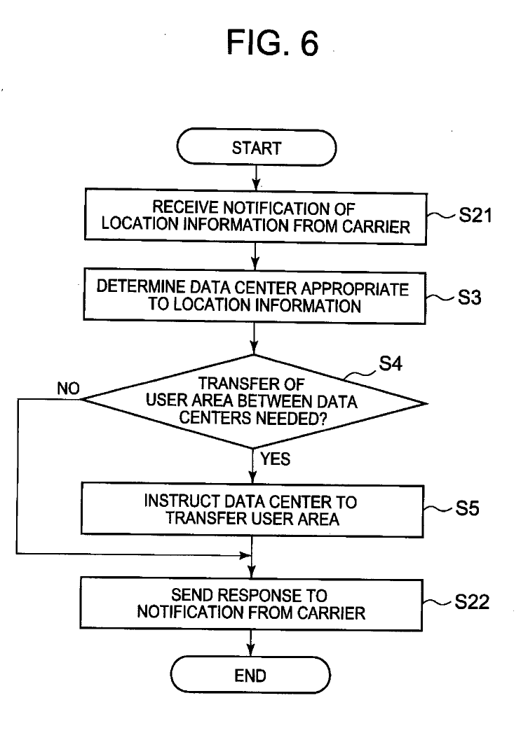

FIG. 6 is a flowchart illustrating an example of a processing progress of the data center management system 1 for a transfer of a user area and the like in the second method. The processes the same as those in the first method are designated by the same reference numerals as those in FIG. 4 and the detailed description of the processes will be omitted. The data center configuration management means 31 of the data center management system 1 constantly monitors the data centers 11a to 11c to collect the usage and operating conditions of the data centers. This point is the same as in the first method.

In the second method, upon detecting the movement of a user's terminal beyond a certain range, a terminal location information providing device (a location information server or a subscription information server) of each network notifies (sends the location information to) the data center management system 1 of the location information on the terminal after the movement. Then, the user location management means 34 of the data center management system 1 receives and stores the location information on the terminal (step S21).

Subsequently, the user location and data center arrangement optimization means 32 determines the appropriate data center in accordance with the location information on the terminal of the user receiving the service (step S3). Further, the user location and data center arrangement optimization means 32 determines whether or not it is necessary to transfer the user area and the user data between data centers (step S4). If determining that it is necessary to transfer the user area and the user data (Yes in step S4), the user location and data center arrangement optimization means 32 instructs the data center currently providing the service to the user to transfer the user area and the user data to the data center determined to be appropriate to the user in step S3 (step S5). The processes in steps S3 to S5 are the same as those in steps S3 to S5 (See FIG. 4) in the first method and therefore the description of the processes is omitted here.

If it is determined that there is no need to transfer the user area and the user data (No in step S4) or if step S5 is performed, the user location management means 34 sends a response to the location information received in step S21 to the location information server or the subscription information server which is a sender of the location information on the terminal of the user (step S22).

If it is determined that there is no need to transfer the user area and the user data and the control proceeds to step S22, the user location management means 34 may send the notice that the transfer of the user area and the user data was not performed to the location information server or the subscription information server which is the sender of the location information on the terminal of the user. Moreover, if the control proceeds to step S22 after the execution of step S5, the user location management means 34 may send the notice that the transfer of the user area and the user data has been performed to the location information server or the subscription information server which is the sender of the location information on the terminal of the user.

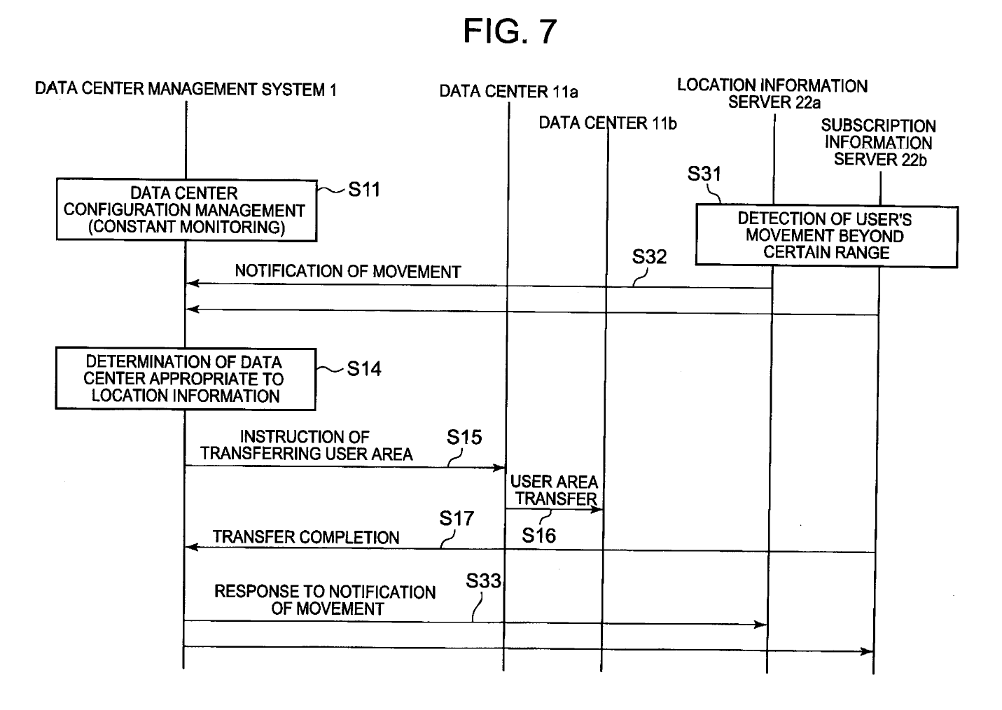

FIG. 7 is an explanatory diagram illustrating exchanges of an instruction and the like between the data center management system, the data centers, the location information server, and the subscription server in the second method.

The data center configuration management means 31 of the data center management system 1 constantly monitors the data centers 11a to 11c to collect the usage and operating conditions of the data centers (step S11). For example, in addition to the system capacity of each data center, the data center configuration management means 31 collects information on the capacity of the user area used by each user, the user data capacity, the CPU occupancy rates of devices in the data center, the type of service provided to the user by the data center, the user's usage condition of the service (which service the user is using), and the like.

A terminal location information providing device (a location information server or a subscription information server) of each network monitors the location information on the terminal of the user of the communication carrier. Then, when detecting the movement of the user's terminal beyond a certain range (step S31), the terminal location information providing device notifies the data center management system 1 of the location information on the terminal obtained after the movement (step S32).

For example, if a terminal which has not been detected until then is detected along with the movement of the user (terminal), the location information servers 22a, 22c, and 22e in the network of the mobile carrier may notify the data center management system 1 of the location information on the terminal. Moreover, if the moving distance of the detected terminal exceeds a certain range, the location information servers 22a, 22c, and 22e may notify the data center management system 1 of the location information on the terminal at that time. Further, for example, if the information on the line installation location of a fixed terminal (the location information on the fixed terminal) contained in the subscription information is updated and the location before the update is a certain distance or more away from the location after the update, the subscription information servers 22b and 22d of the fixed carrier may notify the data center management system 1 of the location information on the fixed terminal after the update.

Immediately after the data center management system 1 receives the location information on the terminal sent in step S32 (step S21: See FIG. 5), the user location management means 34 stores the location information.

In addition, the data center configuration management means 31 collects information on the network (carrier network) in communication used for the communication by the user's terminal from the data centers and the user location management means 34 stores the information, too.

Subsequently, the user location and data center arrangement optimization means 32 determines the appropriate data center in accordance with the location information on the terminal of the user receiving the service (step S14). The process of this step S14 corresponds to the process of step S3 in FIG. 6. Moreover, the process of this step S14 is the same as the process of step S14 in the first method.

Further, the user location and data center arrangement optimization means 32 performs the determination process of step S4 (See FIG. 6) and, if determining that it is necessary to transfer the user area and the like, instructs the data center currently providing the service to the user to transfer the user area and the user data to the data center determined to be appropriate to the user in step S3 (step S 15). The process of step S15 corresponds to the process of step S5 illustrated in FIG. 6. In this specification, the description is made taking a case of instructing the data center 11a to transfer the user area and the user data to the data center 11b as an example. In the data center 11a instructed in step S15, for example, the server 84a requests the server 13b to secure the same user area as the user area of the user, which is secured in the storage 83a, in the storage 12b of the data center 11b. The server 13b of the data center 11b secures the user area in the storage 12b in response to this request. Furthermore, the server 13a of the data center 11a sends the user data of the user to the server 13b of the data center 11b to request the server 13b to store the user data into the user area secured anew. The server 13b stores the user data sent from the data center 11a into the user area secured anew (step S16). The server 13a of the data center 11a may release the user area of the user in the storage 12a. After securing the new user area in the storage 12b and storing the user data sent from the data center 11a into the new user area, the server 13b of the data center 11b notifies the data center management system 1 of the completion of the transfer of the user area and the like (step S 17). The processes of these steps S15 to S17 are the same as those of steps S15 to S17 in the first method.

Upon receiving the notice of step S17, the user location management means 34 notifies the location information server or the subscription information server, which is the sender of the location information on the user's terminal, of the completion of the transfer of the user area and the user data of the user (step S33). The process of this step S33 corresponds to the process of step S22 illustrated in FIG. 6 (if the control proceeds from step S5 to step S22).

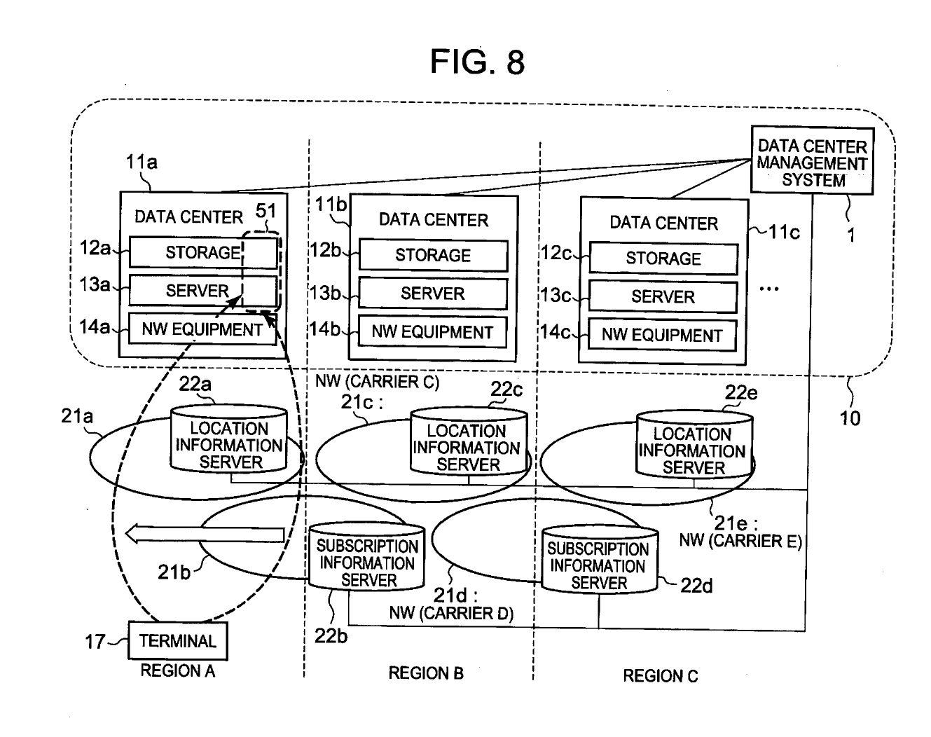

Subsequently, the switching operation of the network (access network) appropriate to the service type will be described. FIG. 8 is a conceptual diagram of a switching operation of a network appropriate to a service type. It is assumed that the user uses a service provided by a cloud service provider via the network 21b of the carrier B. In other words, it is assumed that the user's terminal 17 communicates with the data center 11a via the network 21b and thereby the user receives the service. Then, for example, it is assumed that the service used by the user is a video distribution service requiring, for example, an extremely-high bit rate or a service required to have a short delay time, if any, while the network 21b cannot guarantee such a service quality. If interpreting the situation, the data center management system 1 selects a network able to guarantee the service quality (here, the network is assumed to be the network 21a) and causes the switching of the network used for the communication by the user from the network 21b to the network 21a.

In contrast, it is assumed that the service used by the user is, for example, a service merely requiring a low bit rate such as a text data distribution or a service not required to have the immediacy of communication, while the network 21b of the carrier B has an extremely-high communication quality and requires a high utility rate. If interpreting the situation, the data center management system 1 selects a network that has a minimum required quality of the service and requires a more inexpensive utility rate (here, the network is assumed to be the network 21a) and causes the switching of the network used for the communication by the user from the network 21b to the network 21a.

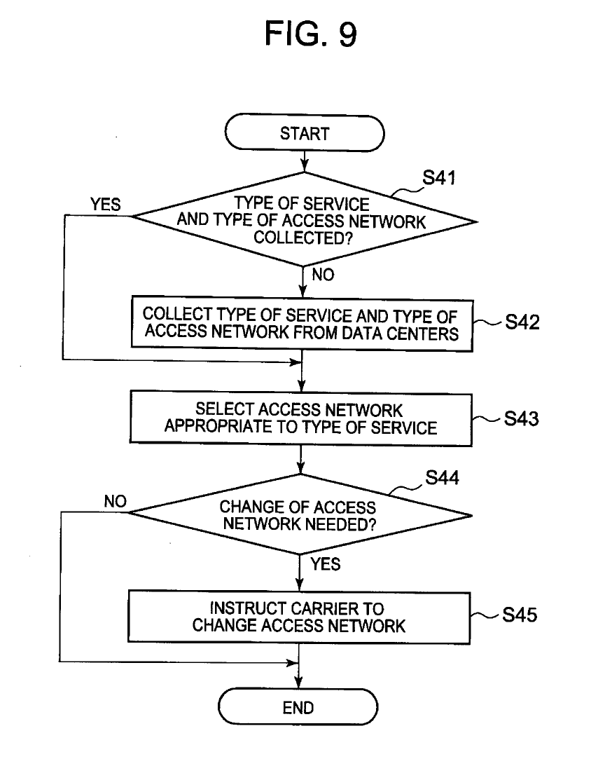

FIG. 9 is a flowchart illustrating an example of a processing progress of the data center management system 1 for network switching. The data center configuration management means 31 of the data center management system 1 determines whether or not the information on the type of service used by the user and the type of access network (network) used by the user is collected (step S41). If the information has already been collected (Yes in step S41), the control proceeds to step S43. Unless the information has been collected, the data center configuration management means 31 collects the information on the type of service used by the user and the type of network used by the user from the data centers (step S42) and the control proceeds to step S43. Here, the information on the type of network is information on the type of communication system such as, for example, 2G, 3G, or LTE.

Therefore, when the control proceeds to step S43, the information on the type of service used by the user and the type of network used by the user becomes referable.

In step S43, the service type and network optimization means 33 determines (selects) a network of a type appropriate to the service used by the user (step S43). For example, the service type and network optimization means 33 may previously store which network is appropriate to which service and select the network appropriate to the service used by the user in step S43. Alternatively, a network appropriate to the service used by the user may be selected in another method.

For example, taking a digital signage service as an example, if the user is using a service of displaying only image data or character information on the terminal, a wide communication bandwidth like in LTE is unnecessary and the requirement for the immediacy is not high. Therefore, as the type of access network appropriate to such a service, 2G (alternatively, 3G, a personal handy-phone system [PHS], or the like) is previously determined and then a network of the determined type is selected.

Moreover, if it is detected that the user is using a service of distributing a video file from video data on the data center, LTE or the like with a wide communication bandwidth and a short communication delay is determined in advance as the type of access network appropriate to the service and then the determined type of network is selected. For example, after the service used by the user is switched to a video file distribution service, switching is performed so as to select the LTE network as described above.

After step S43, the service type and network optimization means 33 determines whether it is necessary to change the network with reference to the type of network currently used by the user collected in step S41 and the type of network determined in step S43 (step S44). If the type of network currently used by the user collected in step S41 differs from the type of network determined in step S43, the service type and network optimization means 33 determines that the network currently used by the user needs to be switched to the network of the type determined in step S43 (Yes in step S44). On the other hand, if the type of network currently used by the user is the same as the type of network determined in step S43, the service type and network optimization means 33 determines that the network does not need to be switched (No in step S44). If determining that the network does not need to be switched, the service type and network optimization means 33 terminates the processing of network switching.

If determining that the network needs to be switched, the service type and network optimization means 33 instructs a communication carrier (specifically, an NW controller) to switch the network (step S45).

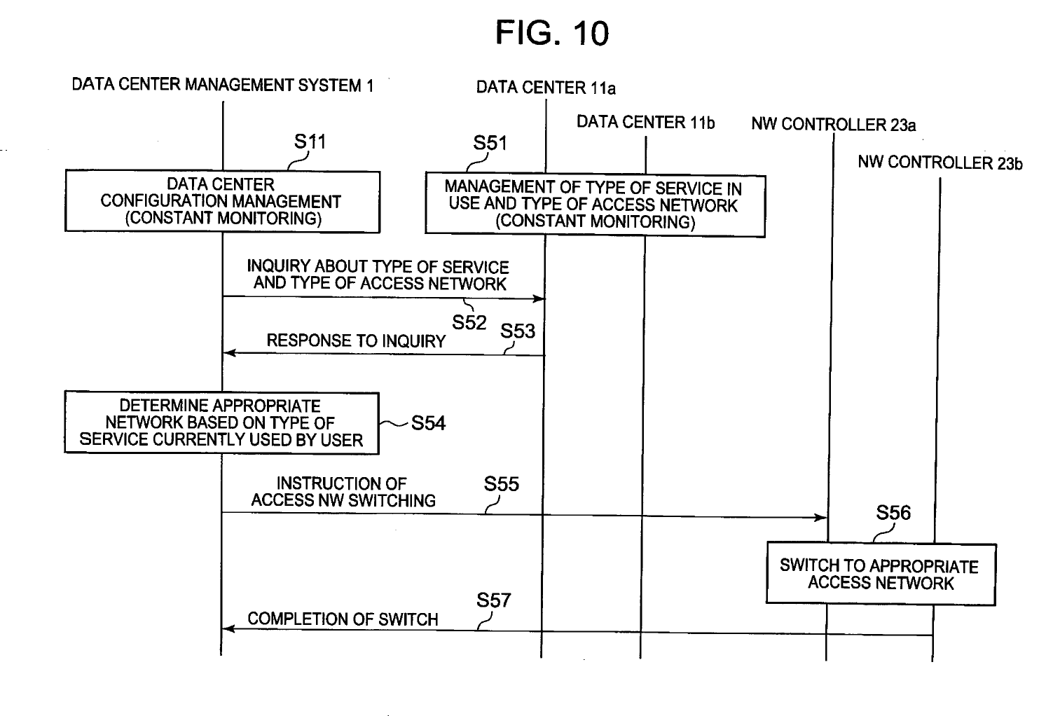

FIG. 10 is an explanatory diagram illustrating exchanges of an instruction and the like between the data center management system, data centers, and NW controllers in the network switching process. The data centers 11a, 11b, and the like constantly monitor the type of service currently used by the user and the type of access network (network) used by the user and retain the information on the type of service currently used by the user and on the network used by the user (step S51).

Moreover, as has been described, the data center configuration management means 31 of the data center management system 1 constantly monitors the data centers 11a to 11c to collect the usage and operating conditions of the data centers (step S11). Specifically, the data center configuration management means 31 inquires of each data center for information on the type of service currently used by the user, the type of network used by the user, and the like (step S52). The data center which has received the inquiry sends the information on the type of service currently used by the user, the type of network used by the user, and the like, as a response to step S52, to the data center management system 1 (step S53) and the data center configuration management means 31 of the data center management system 1 receives the information.

Thereafter, the service type and network optimization means 33 determines the network appropriate to the service on the basis of the type of service currently used by the user (step S54). The process of step S54 corresponds to the process of step S43 in FIG. 9.

The service type and network optimization means 33 then performs the determination process of step S44 (See FIG. 9). If determining that it is necessary to change the network, the service type and network optimization means 33 instructs the NW controller of the network currently used by the user to switch the network (step S55). In the example illustrated in FIG. 10, there is illustrated a case where the network currently used by the user is the network 21a (See FIG. 1) and the NW controller 23a in the network 21a is instructed to switch the network.

When giving the instruction to switch the network (step S55), the service type and network optimization means 33 sends information for specifying a target user for network switching and information for specifying the type of network as a switching destination to the NW controller 23a of the network currently used by the user. The NW controller 23a, which has received the instruction, performs a process of switching the network used by the specified user from the network corresponding to the NW controller 23a to the network corresponding to the NW controller 23b in cooperation with the NW controller (the NW controller 23b in the example illustrated in FIG. 10) in the network corresponding to the specified type of network as the switching destination (step S56). In step S56, the NW controllers 23a and 23b switch the network without changing the IP address allocated to the user's terminal 17. This switching process may be performed by the method described in “3GPP TS23.401” or “3GPP TS23.402” as described above.

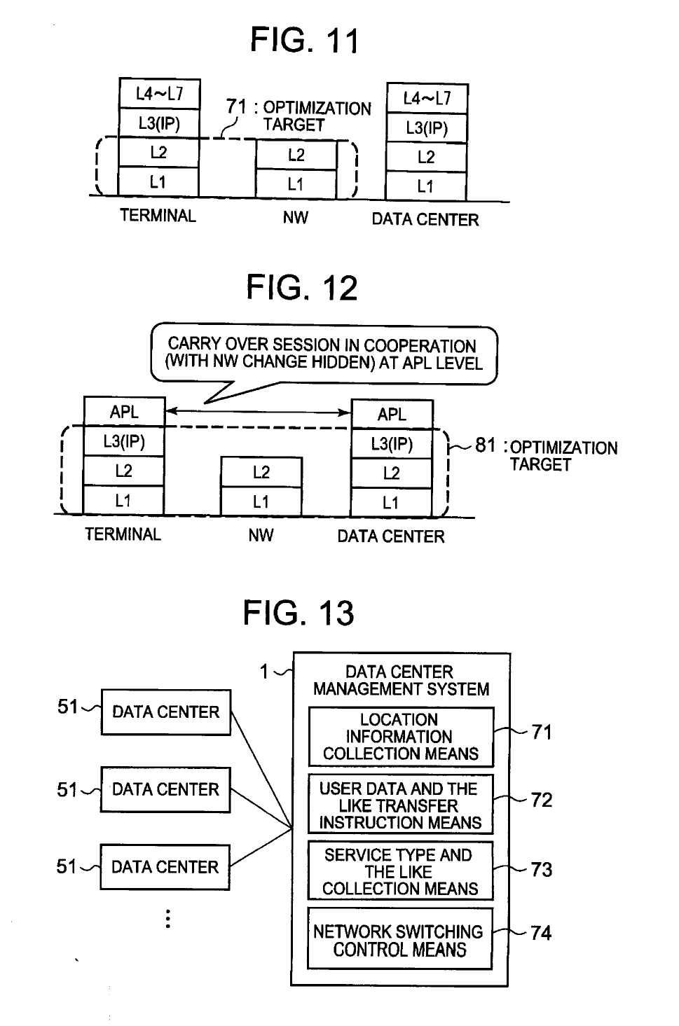

FIG. 11 is an explanatory diagram illustrating an optimization target range 71 for the access network switching in a protocol stack. In the case of switching the network without changing the IP address allocated to the user's terminal 17, L1 and L2 in the network and the terminal are optimized for the network switching as illustrated in FIG. 11.

The NW controller 23a, which has received the instruction in step S55, switches the network of the user to the network appropriate to the service (step S56) and thereafter notifies the data center management system 1 of the completion of the network switching (step S57).

According to the operations described hereinabove, it is possible to provide the same level of services by using an appropriate access network, independently of a user's location with the minimum delay in user access.

According to the exemplary embodiment, the user data and the use area (user area) are able to be dynamically managed according to a user's location, and therefore the user is able to receive services with the same level of delay time independently of the user's location. In addition, for example, if the service used by the user is a service satisfied with a narrow communication bandwidth, it is possible to select a lower-cost access network. Moreover, for example, if the service used by the user is a service requiring a higher QoS, it is possible to select an access network capable of guaranteeing a wide bandwidth and low latency even though the cost is high. In other words, according to the exemplary embodiment, geographic fairness is secured when the user uses the service in the cloud and an access network appropriate to the service type is able to be dynamically managed by a could service provider, instead of by the user, thereby improving the user's convenience.

The following describes a modification of this exemplary embodiment. In the above exemplary embodiment, there has been described a case where the data center management system 1 collects information from the location information servers 22a, 22c, and 22e and the subscription information servers 22b and 22d of the carriers. The data center management system 1 may collect location information on the user's terminal by using a global positioning (GPS) device, which is mounted on a smartphone, a personal computer, or the like used as the user's terminal. In other words, the user's terminal may derive the location information on the terminal itself by using the GPS device provided in the terminal and send the location information to the data center management system 1.

Further, in the above exemplary embodiment, there has been described a case where the network is switched by a carrier-driven method (specifically, the NW controller switches the network). In the case where the terminal is loaded with application software (hereinafter, simply referred to as the application) capable of switching among a plurality of sessions, the network switching may be made by the control of the data centers and the terminal. Specifically, the data center management system 1 may instruct the data centers and the terminal to perform network switching.

FIG. 12 is an explanatory diagram illustrating an optimization target range 81 for performing access network switching in this case. In the case of performing network switching by using data centers and the terminal, as illustrated in FIG. 12, all of the L3 and lower layers in the protocol stack are targets of switching and therefore the control by the access network (network) is unnecessary.

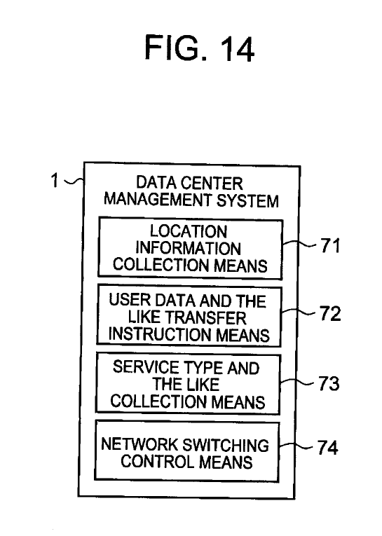

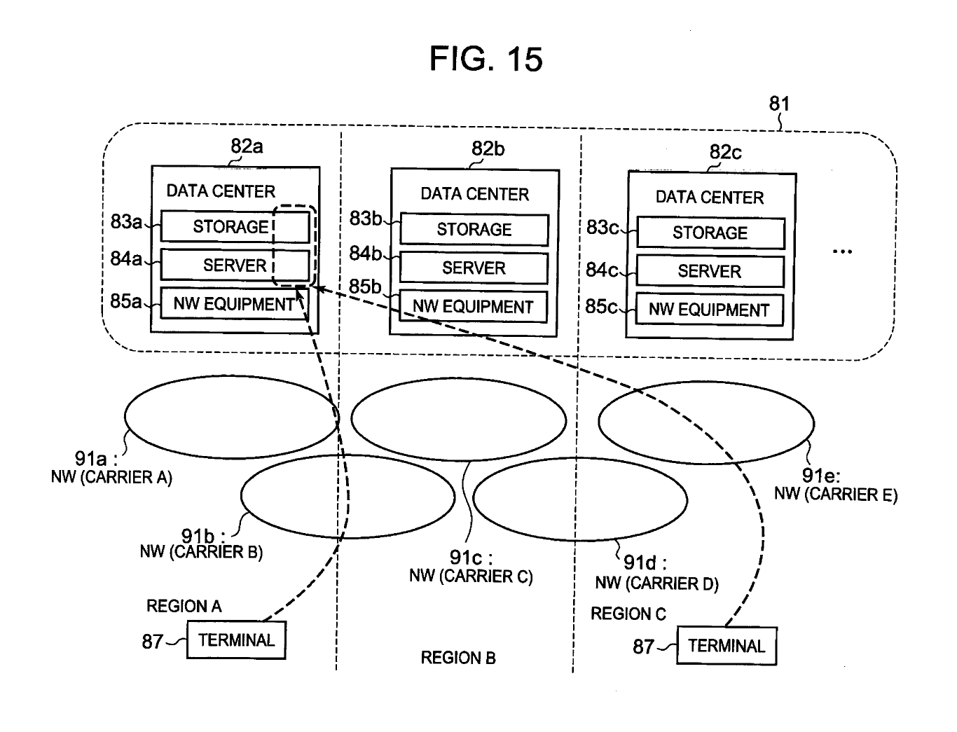

The following describes an example of a minimum configuration of the present invention. FIG. 13 is a block diagram illustrating a minimum configuration example of the communication service providing system of the present invention. FIG. 14 is a block diagram illustrating a minimum configuration example of the data center management system of the present invention.

The communication service providing system according to the present invention includes a plurality of data centers 51, which provide services to the user by communicating with the user's terminal, and a data center management system 1 which manages the data centers 51. When providing the service to the user, each of the data centers 51 secures a user area, which is a storage area for the user for use in providing the service, and stores user data, which is data for the user for use in providing the service, into the user area.

The data center management system 1 includes location information collection means 71 (for example, the user location management means 34), user data and the like transfer instruction means 72 (for example, the user location and data center arrangement optimization means 32), service type and the like collection means 73 (for example, the data center configuration management means 31), and network switching control means 74 (for example, the service type and network optimization means 33).

The location information collection means 71 collects the location information on the terminal of the user receiving a service from any one of the data centers.

The user data and the like transfer instruction means 72 determines a data center closest to a location indicated by the location information. If the data center concerned differs from the data center currently providing a service to the user, the user data and the like transfer instruction means 72 instructs the data center currently providing the service to the user to transfer the user data and the user area of the user to the data center closest to the location indicated by the location information.

The service type and the like collection means 73 collects information on the type of service provided to the user and the type of network used for providing the service to the user from the respective data centers.

The network switching control means 74 determines the type of network appropriate to the type of service provided to the user by the data center. If the type of the network does not match the information on the type of network collected by the service type and the like collection means, the network switching control means 74 performs control to switch the network used for providing the service to the user to the network appropriate to the type of the service.

The advantageous effects of the present invention are achieved by the configuration described hereinabove.

Moreover, for example, if the type of network appropriate to the type of service provided to the user by the data center does not match the information on the type of network collected by the service type and the like collection means, the network switching control means 74 instructs the network switching means in the network used for providing the service to the user to switch the network used for the communication between the terminal and the data center to the network appropriate to the type of the service.

The location information collection means 71 may collect the location information on the user's terminal from the terminal location information providing devices managed by the respective communication carriers.

The location information collection means 71 may collect the location information on the terminal from the user's terminal.

Some or all of the above exemplary embodiments can be described as follows, but are not limited to the following.

(Supplementary Note 1) A communication service providing system including: a plurality of data centers which provide services to a user by communicating with a terminal of the user; and a data center management system which manages the respective data centers, wherein: each data center, when providing the service to the user, secures a user area which is a storage area for the user for use in providing the service and stores user data which is data for the user for use in providing the service into the user area; and the data center management system includes: a location information collection unit which collects location information on the terminal of the user receiving the service from any one of the data centers; a user data and the like transfer instruction unit which determines a data center closest to a location indicated by the location information and, in the case where the data center differs from the data center currently providing the service to the user, instructs the data center currently providing the service to the user to transfer the user data and the user area of the user to the data center closest to the location indicated by the location information; a service type and the like collection unit which collects information on the type of service provided to the user and the type of network used for providing the service to the user from the respective data centers; and a network switching control unit which determines the type of network appropriate to the type of service provided to the user by the data center and, in the case where the type of network does not match the information on the type of network collected by the service type and the like collection unit, performs control to switch the network used for providing the service to the user to the network appropriate to the type of service.

(Supplementary Note 2) The communication service providing system according to Note 1, wherein, in the case where the type of network appropriate to the type of service provided to the user by the data center does not match the information on the type of network collected by the service type and the like collection unit, the network switching control unit instructs a network switching unit in the network used for providing the service to the user to switch the network for the communication between the terminal and the data center to the network appropriate to the type of service.

(Supplementary Note 3) The communication service providing system according to Note 1 or 2, wherein the location information collection unit collects the location information on the user's terminal from terminal location information providing devices managed by respective communication carriers.

(Supplementary Note 4) The communication service providing system according to Note 1 or 2, wherein the location information collection unit collects the location information on the terminal from the user's terminal

(Supplementary Note 5) A data center management system which manages a plurality of data centers which provide services to a user by communicating with a terminal of the user, secures a user area which is a storage area for the user for use in providing the services when providing the services to the user, and stores user data which is data for the user for use in providing the services into the user area, the system including: a location information collection unit which collects location information on the terminal of the user receiving the service from any one of the data centers; a user data and the like transfer instruction unit which determines a data center closest to a location indicated by the location information and, in the case where the data center differs from the data center currently providing the service to the user, instructs the data center currently providing the service to the user to transfer the user data and the user area of the user to the data center closest to the location indicated by the location information; a service type and the like collection unit which collects information on the type of service provided to the user and the type of network used for providing the service to the user from the respective data centers; and a network switching control unit which determines the type of network appropriate to the type of service provided to the user by the data center and, in the case where the type of network does not match the information on the type of network collected by the service type and the like collection unit, performs control to switch the network used for providing the service to the user to the network appropriate to the type of service.

This application claims priority to Japanese Patent Application No. 2010-273746 filed on Dec. 8, 2010, and the entire disclosure thereof is hereby incorporated herein by reference.

Although the present invention has been described with reference to the exemplary embodiments hereinabove, the present invention is not limited thereto. A variety of changes, which can be understood by those skilled in the art, may be made in the configuration and details of the present invention within the scope thereof.

### INDUSTRIAL APPLICABILITY

The present invention is preferably applied to a communication service providing system which provides services from data centers via a network.

### REFERENCE SIGNS LIST

1 Data center management system
11a, 11b, 11c Data center
17 Terminal
22a, 22c, 22e Location information server
22b, 22d Subscription information server
23a, 23b NW controller
31 Data center configuration management means
32 User location and data center arrangement optimization means
33 Service type and network optimization means
34 User location management means
35 Data center communication means
36 Carrier system communication means

What is claimed is:

1. A communication service providing system comprising:
a plurality of data centers which provide services to a user by communicating with a terminal of the user; and
a data center management system which manages the respective data centers, wherein:
each data center, when providing the service to the user, secures a user area which is a storage area for the user for use in providing the service and stores user data which is data for the user for use in providing the service into the user area; and
the data center management system includes:
a location information collection unit for collecting location information on the terminal of the user receiving the service from any one of the data centers;
a user data and the like transfer instruction unit for determining a data center closest to a location indicated by the location information and, in the case where the data center differs from the data center currently providing the service to the user, instructing the data center currently providing the service to the user to transfer the user data and the user area of the user to the data center closest to the location indicated by the location information;
a service type and the like collection unit for collecting information on the type of service provided to the user and the type of network used for providing the service to the user from the respective data centers; and
a network switching control unit for determining the type of network appropriate to the type of service provided to the user by the data center and, in the case where the type of network does not match the information on the type of network collected by the service type and the like collection unit, performing control to switch the network used for providing the service to the user to the network appropriate to the type of service.

2. The communication service providing system according to claim 1, wherein, in the case where the type of network appropriate to the type of service provided to the user by the data center does not match the information on the type of network collected by the service type and the like collection unit means, the network switching control unit instructs a network switching unit in the network used for providing the service to the user to switch the network for the communication between the terminal and the data center to the network appropriate to the type of service.

3. The communication service providing system according to claim 1, wherein the location information collection unit collects the location information on the user's terminal from terminal location information providing devices managed by respective communication carriers.

4. The communication service providing system according to claim 1, wherein the location information collection unit means collects the location information on the terminal from the user's terminal.

5. A data center management system which manages a plurality of data centers which provide services to a user by communicating with a terminal of the user, secures a user area which is a storage area for the user for use in providing the services when providing the services to the user, and stores user data which is data for the user for use in providing the services into the user area, the system comprising:
a location information collection unit for collecting location information on the terminal of the user receiving the service from any one of the data centers;
a user data and the like transfer instruction unit for determining a data center closest to a location indicated by the location information and, in the case where the data center differs from the data center currently providing the service to the user, instructing the data center currently providing the service to the user to transfer the user data and the user area of the user to the data center closest to the location indicated by the location information;
a service type and the like collection unit for collecting information on the type of service provided to the user and the type of network used for providing the service to the user from the respective data centers; and
a network switching control unit for determining the type of network appropriate to the type of service provided to the user by the data center and, in the case where the type of network does not match the information on the type of network collected by the service type and the like collection unit, performing control to switch the network used for providing the service to the user to the network appropriate to the type of service.

6. A method of providing communication service, wherein:
a plurality of data centers provide services to a user by communicating with a terminal of the user;
each data center, when providing the service to the user, secures a user area which is a storage area for the user for use in providing the service and stores user data which is data for the user for use in providing the service into the user area; and
a data center management system which manages the respective data centers performs the operations of:
collecting location information on the terminal of the user receiving the service from any one of the data centers;
determining a data center closest to a location indicated by the location information and, in the case where the data center differs from the data center currently providing the service to the user, instructing the data center currently providing the service to the user to transfer the user data and the user area of the user to the data center closest to the location indicated by the location information;
collecting information on the type of service provided to the user and the type of network used for providing the service to the user from the respective data centers; and
determining the type of network appropriate to the type of service provided to the user by the data center and, in the case where the type of network does not match the collected information on the type of network, performing control to switch the network used for providing the service to the user to the network appropriate to the type of service.

7. (canceled)
